(19) United States
(12) Patent Application Publication
(10) Pub. No.: US 2009/0005242 A1
(43) Pub. Date: Jan. 1, 2009

(54) Catalyst for Synthesizing Hydrocarbons C5-C100 and Method of Preparation Thereof

(75) Inventors: Alla Yurevna Krylova, Moscow (RU); Yanina Vladislavovna Mikhailova, Moskovskaya obl. (RU); Sergey Alexandrovich Svidersky, Moscow (RU)

Correspondence Address: Aleksandr Smushkovich, Post Office Box 140505, Brooklyn, NY, 11214, US

(73) Assignee: LIMITED LIABILITY COMPANY "UNITED RESEARCH AND DEV, Moscow (RU)

(21) Appl. No.: 11/885,496

(22) PCT Filed: Mar. 2, 2006
(86) PCT No.: PCT/RU06/00095

§ 371 Date: Sep. 1, 2007

(30) Foreign Application Priority Data
Mar. 4, 2005 (RU) 2005105984

(51) Int. Cl. B01J 23/89; B01J 21/02; B01J 23/75; B01J 23/70; B01J 23/40; B01J 23/44; B01J 23/36

(52) U.S. Cl. 502/327; 502/332

(57) ABSTRACT

The invention relates to petroleum, gas, and coal chemistry, especially to catalysts for C₅-C₁₀₀ hydrocarbons synthesis in particular from CO and H₂ and a method for producing such catalyst. The proposed catalyst comprises an aluminum-oxide-based support obtainable from a gibbsite structure of aluminum hydroxide and cobalt, which content ranges from 15 to 50 wt %. The method comprises preparation of an alumina based support by mixing cobalt compounds with aluminum hydroxide and calcination, wherein the aluminum hydroxide having a structure of gibbsite, the mixing provided in the dry form with a mole ratio of cobalt and aluminum in the range of from 1:1 to 1:30; impregnation of the support in two or more stages with a water solution of cobalt salt; and thermal treatment. Embodiments include providing the thermal treatment by drying and/or calcination, additional introduction of substances-promoters into the support through impregnation with salts solution of the promoters.

### CROSS-REFERENCE TO RELATED APPLICATIONS

This application is a U.S. national phase application of a PCT application PCT/RU2006/000095 filed on 2 Mar. 2006, published as WO2006/093435, whose disclosure is incorporated herein in its entirety by reference, which PCT application claims priority of a Russian Federation patent application RU2005/105984 filed on 4 Mar. 2005.

### FIELD OF THE INVENTION

The present invention relates to petrochemistry, gas chemistry, coal chemistry, particularly to catalyst for synthesis of hydrocarbons C₅-C₁₀₀ from CO and H₂, methods for preparing the aforesaid catalyst, and methods for producing aliphatic hydrocarbons C₅-C₁₀₀ with the aforesaid catalyst.

### BACKGROUND OF THE INVENTION

Natural gas finds wide application as fuel. Today natural gas is mainly used in the power-production industry (20-25%), general industry (35-40%), as well as an energy source for households (˜40%). The importance of natural gas is expected to steadily grow in the nearest future. Methods of chemical processing of natural and associated petroleum gases into liquid hydrocarbons are subject of great interest as alternative methods for producing motor fuels (gasoline, diesel fuel, jet fuel). This interest rises many times in the periods of oil crises caused by political instability in oil-producing regions of the world, and resulting in a sharp increase of oil and oil products prices.

The development of natural gas processing in the world directly depends on the distance between gas fields and consumers that is on the transportation cost. Natural gas is typically transported in a compressed form through pipelines or in a liquefied form in special tankers. One of the known methods for the natural gas transportation includes its chemical conversion into liquid hydrocarbon products at the production site, and transportation of these liquid products by traditional means: railroads, ships, etc. In some cases the latter method turns out to be less expensive for natural gas transportation.

Special interest to the issues of carbon-bearing gases is also related to ecological problems. To create ecologically safe and wasteless technologies of oil production, development of advanced methods for utilization of associated petroleum gases is the most acute. One of such methods includes production of synthetic oil with a GTL (“Gas-to-liquid”) technology, further transportation of the synthetic oil, and refining it together with crude oil.

The GTL technology is currently the main method for production of synthetic motor fuel. The modem GTL process in its hydrocarbon version is a three stage technology with catalytic reactions. In a first stage, low-activity paraffins making the major part of natural and associated gases are converted into more reactive mixture of carbon oxide and hydrogen (conventionally known as “syngas”). For this purpose, steam or auto-thermal reforming is mainly used. In rare cases partial oxidation is utilized. A second stage is a synthesizing of hydrocarbons from CO and H₂ (known as “Fischer-Tropsch synthesis”). At a third stage, hydrocarbon products are enhanced to marketable quality using hydro-cracking or hydro-isomerization.

The intrinsic or “ideological” stage of GTL process is the Fischer-Tropsch synthesis, since this reaction determines the resultant amount and composition of the hydrocarbons obtained, as well as the necessity and type of further refining of the products. Interest to this reaction becomes even greater as it allows for the conversion into liquid hydrocarbon mixtures of syngas produced not only from natural or associated gas but also from any carbon source (coal, peat, biomass, etc.).

Synthesis of hydrocarbons from CO and H₂ is mainly carried out with application of iron or cobalt catalysts; however the latter are definitely preferred, as they are selective to linear paraffins. In their presence, only insignificant amounts of olefins and oxygen-containing compounds are formed.

In many aspects, the efficiency of this stage depends on the ability of the applied catalyst to facilitate the reaction with a minimal outcome of gaseous hydrocarbons (main byproducts), especially methane, as it is a feed raw component (feedstock) for the GTL process. Nowadays, researchers are focused on the development of catalysts with high ability of polymerization and lowered selectivity to the methane formation.

The ability of polymerization is assessed by an “alpha” value in Schultz-Flory equation describing molecular-mass distribution of the hydrocarbons formed: Wₙ=(1−α)²·n·αⁿ⁻¹, where Wₙ—is a mass fraction of n-paraffin with a carbon number n; n—is a number of carbon atoms; α—is a constant, characterizing a probability of the hydrocarbon chain growth.

The higher α, the more selective the catalyst is to the formation of heavy hydrocarbon products. For synthesis of high-molecular hydrocarbons from CO and H₂, for example, catalysts are used allowing making hydrocarbon mixtures with α=0.9, with a share of paraffin wax (C₁₉₊) of 40%. Theoretically, the selectivity index to methane in this case is near 1%. However, due to a side reaction of direct hydrogenation of CO (CO+H₂=CH₄+H₂) under real conditions of the Fischer-Tropsch synthesis, this index significantly exceeds the aforesaid theoretic value.

For synthesis of high-molecular hydrocarbons from CO and H₂ cobalt catalysts are mainly used containing aluminum oxide (alumina) as a support layer (U.S. Pat. Nos. 4,801,573; 5,028,634; 6,271,432, European Patent Application EP 0313375). In most of the cases, the feedstock for Al₂O₃ is boehmite AlO(OH). Boehmite is produced by means of dehydration of Al(OH)₃ possessing crystallographic structure of gibbsite or bayerite.

In catalysis and, in particular in the Fischer-Tropsch synthesis, γ-alumina finds the widest application being most frequently produced from boehmite AlO(OH), which in its turn, is mainly produced by means of hydration of Al(OH)₃, possessing crystallographic structure of bayerite. The γ-Al₂O₃ support layer, produced in this way, is covered by metals (in particular, cobalt) that are applied in several stages from solutions of salts with further calcination at each stage to fix the salt component on the support. However, experiments show that catalysts Co/γ-Al₂O₃, used for the Fischer-Tropsch synthesis, due to specific features of the support's structure, are very sensitive to temperature.

γ-Al₂O₃ is known to have a spinel structure, in which atoms of aluminum locate partially in tetrahedrons and partially in octahedrons. When cobalt reacts with alumina, atoms of cobalt are capable of replacing atoms of aluminum in both positions (Journal of Catalysis, 1985, v. 93, p. 38). Thermal treatment of such a catalyst (calcination, reduction, hydro-thermal treatment) results in enhanced reaction of cobalt with alumina with dominating formation of hard-to-reduce spinel CoAl₂O₄. Catalysts containing spinel are described, for instance, in patent EP 1239019 and application US 2004/0204506. Normally they are characterized by insufficient activity as the formation of spinels and spinel-like structures results in a lower extent of cobalt reduction and, as a consequence, in decreasing the catalyst active surface. To eliminate these disadvantages a noble metal (most frequently Pt or Ru) is added to cobalt-alumina catalyst favouring more complete reduction of cobalt from such cobalt-alumina compounds.

The closest equivalent to the catalyst proposed in this invention is the catalyst for synthesis of hydrocarbons C₅-C₁₀₀ from CO and H₂ based on cobalt and developed by ConocoPhillips company (US2004/0132833A1), which catalyst containing γ-alumina stable in hydro-thermal conditions as the support. The method for preparing this catalyst includes thermal treatment of Boehmite with obtaining γ-alumina, on which cobalt nitrate is applied by means of impregnation in several stages.

In addition to cobalt and γ-Al₂O₃ the aforesaid catalyst contains a noble metal of group VIII (Pt or Ru) favouring reduction of cobalt from mixed oxides of cobalt and aluminum and/or some other promoters, which are also added to the catalyst by means of impregnation. The catalysts so developed allow for synthesis of hydrocarbons from CO and H₂ in a fixed bed of the catalyst at a temperature in the range of 200-230° C. and a pressure of approximately 25 bars with a productivity in terms of hydrocarbons C₅₊, from 500 to 800 g/h/kg of catalyst and a selectivity to methane from 8 to 10%.

However the aforesaid catalytic system is characterized by insufficiently low selectivity to the methane formation, which is about from 8 to 10%, and in some cases reaches 15-20%.

### Disclosure of Invention

### BRIEF DESCRIPTION OF THE INVENTION

The primary aim of the invention is the creation of a catalyst for synthesis of hydrocarbons C₅-C₁₀₀, which catalyst should possess a higher activity and selectivity to hydrocarbon products with high molecular weight, an improved stability to changes in temperature regimes, and a lowered selectivity to formation of methane (by-product of the reaction), as well as the providing of a method for preparation of such catalyst. Other aims of the invention might become apparent to a person skilled in the art from a consideration of the appended drawings, ensuing description, and claims as hereinafter related.

The aforesaid aim is achieved by making a catalyst for synthesis of hydrocarbons C₅-C₁₀₀ comprising a support, based on alumina, produced, in accordance with the invention, from aluminum hydroxide with a structure of the gibbsite and cobalt, wherein the cobalt content share constitutes from 15 to 50 wt. %.

The use of aluminum hydroxide with a gibbsite structure allows forming a layer, preventing formation of hard-to-reduce spinel CoAl₂O₄, which ensures maintaining the cobalt's ability to reduce, and hence a higher catalyst activity and selectivity to formation of hydrocarbon products with a high molecular weight.

It was found that application of the aforesaid catalyst in synthesis of hydrocarbons from CO and H₂ resulted in high selectivity to hydrocarbons C₅₊ (about 90%) and low selectivity to methane (less than 5 wt. %). It should be noted that the catalysate mainly contains normal paraffins (about 80%). The aforesaid catalyst is characterized by a high polymerizing ability: α value is equal to 0.9-0.97 and share of hydrocarbons C₁₁₊ in products is 80-85%.

In a particular embodiment of this invention, the catalyst additionally comprises at least one of the metals of groups VII-VIII of Mendeleev's Periodic Table, which also favours the reduction of cobalt.

The aforementioned aim is also achieved by providing a method for preparing a catalyst for synthesis of hydrocarbons C₅-C₁₀₀ comprising: preparation of an alumina based support by mixing cobalt compounds with aluminum hydroxide and calcination, wherein the aluminum hydroxide having a structure of gibbsite, the mixing is provided in the dry form with a mole ratio of cobalt and aluminum in the range of from 1:1 to 1:30; impregnation of the support in two or more stages with a water solution of cobalt salt; and thermal treatment in accordance with this invention.

The increase of selectivity to high-molecular hydrocarbons and stability is achieved due to the proposed method for preparing the cobalt-aluminum catalyst, which catalyst is characterized by a lowered interaction of cobalt with the support.

For preparing γ-Al₂O₃, gibbsite and boehmite are used as initial materials that are known to differ substantially from each other in their crystallographic structures. Four-coordinated atoms of aluminum as part of the bayerite (and boehmite) structure, together with oxygen and water, form solid strips and two-dimensional layers linked to each other with hydrogen bonds (see FIG. 3).

The inventors of the present invention have established that ions of cobalt actively react with bayerite and especially with boehmite, replacing aluminum in the tetrahedral positions, even under a mechanical intermingling, without thermal treatment, which favours formation of cobalt-aluminum spinel reduced by hydrogen at a temperature higher than 900° C. during the further calcination.

The structure of gibbsite is more volumetric, atoms of aluminum in this structure are six-coordinated. Together with oxygen and water they are linked into six-member rings, bonded with hydrogen bonds (see FIG. 2). Substitution of aluminum located in the octahedral position with ions of cobalt, during further calcination, results in the formation of mixed oxides of cobalt and aluminum, capable of reducing at temperatures below 500° C. An oxide layer is thus formed on the surface of the alumina body, preventing reaction of the residual cobalt with the support in the further process of impregnation with water solution of cobalt salt and the further calcination.

The thermal treatment can be performed by drying and/or calcination.

In an embodiment of this invention, substances-promoters are additionally introduced through impregnation of the support by means of solutions of the promoters' salts. Metals of groups VII-VIII of Mendeleev's Periodic Table are typically used as the promoters.

### BRIEF DESCRIPTION OF THE DRAWINGS

FIG. 1 shows a diagram of aluminum hydroxides of various structure conversion into alumina Al₂O₃.

FIG. 2 shows the structure of gibbsite.

FIG. 3 shows the structure of boehmite.

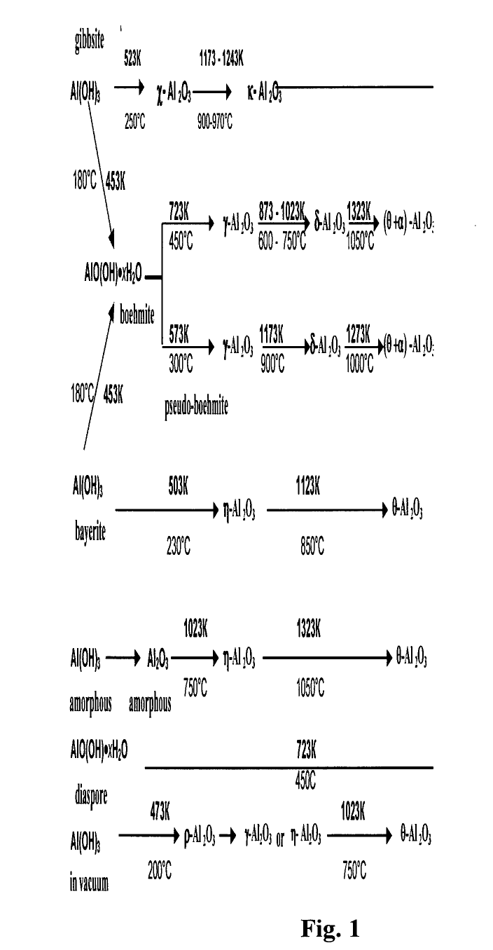

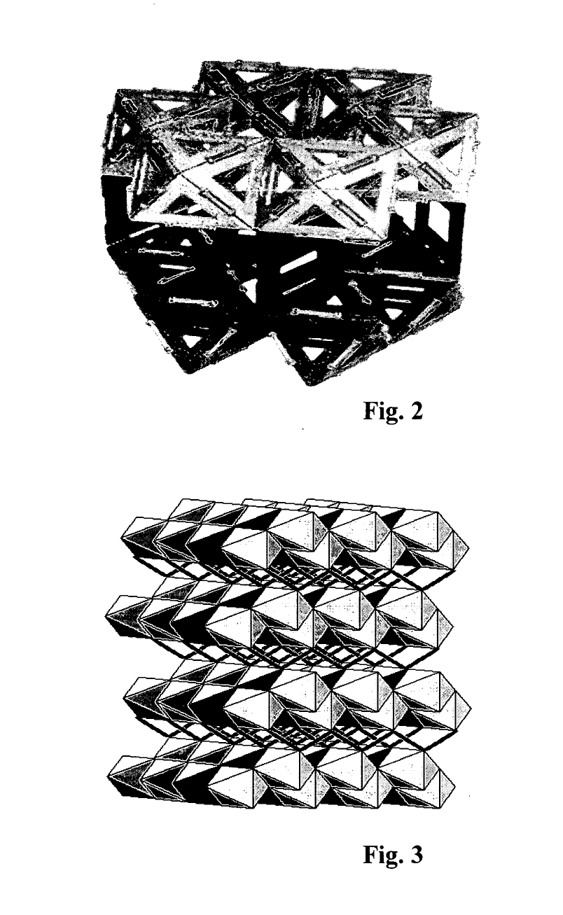

### DETAIL DESCRIPTION OF PREFERRED EMBODIMENTS & BEST MODE OF THE INVENTION

While the invention may be susceptible to embodiment in different forms, there are shown in the drawings, and will be described in detail herein, specific embodiments of the present invention, with the understanding that the present disclosure is to be considered an exemplification of the principles of the invention, and is not intended to limit the invention to that as illustrated and described herein.

The inventive method for preparing of a cobalt-aluminum catalyst comprises: mechanical mixing of part of cobalt in the form of cobalt salt and aluminum hydroxide with the structure of gibbsite with further calcination to make a layer preventing formation of hard-to-reduce spinel CoAl₂O₄, after which consecutive (second, third, etc.) stages of impregnation with a cobalt salt solution are carried out to add the rest cobalt up to the content of from 15 to 50 wt. %, preferably in the range of from 20 to 40 wt. %, with intermediate stages of drying and calcination.

It was established that application of the catalyst, made according to this invention, in the synthesis of hydrocarbons from CO and H₂ results in high selectivity to hydrocarbons C₅₊ (about 90%) and low selectivity to methane (less than 5%). It should be noted that the resultant catalysate mainly contains normal paraffins (about 80%). The catalyst is characterized by high polymerizing power: value α, calculated based on the mentioned Shultz-Flory equation, is in the range of from 0.9 to 0.97, and the share of hydrocarbons C₁₁₊ in the products of synthesis is 80-85%.

At the first stage of the catalyst preparation, oxide, nitrate, formiate, carbonate, basic carbonate, acetate, acetylacetonate, etc. are used as cobalt compounds. The thus obtained cobalt compound containing from 5 to 20 wt. % of the metal (preferably from 10 to 15 wt. %) is mechanically (manually or with a mechanical sieve) intermingled with aluminum hydroxide, and calcined during a period from 1 to 24 hours (preferably from 5 to 15 hours) at a temperature in the range from 350 to 1000° C. (preferably from 500 to 1000° C.). The remaining part of the active component (cobalt) is applied with several stages of impregnation with cobalt salts (nitrate, acetate, formiate, acetylacetonate, etc.). At each stage the sample is dried at water base and the obtained catalyst precursor is dried and/or calcined in the flow of air at a temperature in the range from 100 to 1000° C. (preferably from 300 to 500° C.) during a period of time from 0.5 to 10 hours (preferably from 1 to 5 hours).

Before conducting the synthesis, a sample of the catalyst is activated by reduction in the stream of hydrogen at a temperature in the range from 300 to 600° C. (preferably from 350 to 500° C.) during a time period from 0.5 to 5 hours (preferably from 0.5 to 2.5 hours).

Synthesis of hydrocarbons from CO:H₂ is conducted in a tubular reactor with a fixed bed of catalyst under a pressure in the range from 1 to 50 bar (preferably, from 10 to 30 bar) and a temperature in the range from 150 to 300° C. (preferably, from 180 to 230° C.). The mole ratio of CO:H₂ in syngas is in the range from 1:1 to 1:3 (preferably 1:2).

The following specific examples of the invention implementation are provided for better explanation of the invention.

### EXAMPLE 1

A sample of catalyst comprising 32% Co/Al₂O₃ is prepared as follows in a three stages process.

Stage-1. Cobalt carbonate is mechanically mixed with aluminum hydroxide of the gibbsite structure at Al/Co=6 (mol.). The resultant mixture is then calcined in a muffle at a temperature T=600° C. during 10 hours. At this stage, a formation of spinel CoAl₂O₄ was not identified by the X-ray phase analysis.

Stage-2. 18.5 g of cobalt nitrate is dissolved in distilled water and added to 30 g of the material obtained at the Stage-1. The resultant mixture is placed into a porcelain cup and dried at water base for 30-60 minutes, after which it is calcined at a temperature of 400° C. during 1 hour.

Stage-3. 18.5 g of cobalt nitrate is dissolved in distilled water and added to 30 g of the material obtained at the Stage-2. The resultant mixture is placed into a porcelain cup and dried at water base during 30-60 minutes.

Before the synthesis, the catalyst sample is activated in a stream of hydrogen at a temperature from 350 to 600° C. (preferably from 400 to 450° C.) during 1 hour. The synthesis of hydrocarbons is conducted in a tubular reactor with a fixed bed of catalyst under the atmospheric pressure and in the temperature range from 150 to 220° C. using syngas with CO/H₂=1/2 (mol.).

### EXAMPLES 2, 3, AND 4

Catalyst is prepared similar to Example 1 except for adding cobalt at the Stage-1 in different ratios of Al/Co equal to 12, 9, and 3 (mol.), respectively. In such cases, the total content of cobalt in the catalyst makes 27, 29 and 38%, respectively.

### EXAMPLE 5

Catalyst is prepared similar to Example 1 except for using dehydrated aluminum hydroxide of the boehmite structure for preparation of the support. The X-ray phase analysis at the Stage-1 of the catalyst preparation identified a formation of spinel-like structures.

### EXAMPLE 6

Catalyst is prepared similar to Example 1 except for using cobalt nitrate at the Stage-1 of the catalyst preparation similar to the Stage-2.

### EXAMPLE 7

Catalyst sample with the composition as 32% Co-0.5% Re/Al₂O₃ is prepared as follows in a four stages process.

Stage-1. Cobalt carbonate is mechanically mixed with aluminum hydroxide of the gibbsite structure at Al/Co/Co=6 (mol.). The mixture is then calcined in muffle at a temperature T=600° C. during 10 hours. At this stage, a formation of spinel CoAl₂O₄ was not identified with the X-ray phase analysis.

Stage-2. 18.5 g of cobalt nitrate is dissolved in distilled water and added to 30 g of material obtained at the Stage-1. The resultant mixture is placed into a porcelain cup and dried at water base for 30-60 minutes after which it is calcined at a temperature of 400° C. during 1 hour.

Stage-3. 0.21 g of ammonium perrhenate is dissolved in distilled water and added to the material obtained at the Stage-2. The resultant mixture is placed into a porcelain cup and dried at water base for 30-60 minutes after which it is calcined at a temperature of 450° C.( during 1 hour.

Stage 4. 18.5 g of cobalt nitrate is dissolved in distilled water and added to the material obtained at the Stage-3. The mixture is placed into a porcelain cup and dried at water base for 30-60 minutes.

Before the synthesis, the catalyst sample is activated in a stream of hydrogen at a temperature of 450° C. during 1 hour. Reduction and testing of the catalyst sample is carried out as described in Example 1.

### EXAMPLE 8

The catalyst prepared and activated as described in Example 6 is used for synthesis. The synthesis of hydrocarbons is conducted in a tubular reactor with a fixed bed of catalyst under a pressure of 20 bar and in the temperature range from 150 to 250° C. using syngas with CO/H₂=1/2 (mol.).

### EXAMPLE 9

The composition and method of the catalyst preparation are similar to the ones described in Example 7 except for applying Pd instead of Re. Activation and conditions of the synthesis correspond to the ones described in Example 1.

### EXAMPLE 10

Composition and method of the catalyst preparation are similar to the described in Example 7 except for applying Ru instead of Re. Activation and conditions of synthesis correspond to the described in Example 1.

The results of testing samples of the catalysts prepared and tested according to Examples 1-10 are shown in the TABLE below.

TABLE
Indices of hydrocarbons synthesis from CO and H₂ carried out with
samples of the catalysts according to the invention

| | Conversion | Selectivity to | Selectivity to | [C₁₁₊], | |
|---|---|---|---|---|---|
| Example | of CO, % | CH₄, % | C₅₊, % | wt. % | α |
| 1 | 58 | 3 | 93 | 86 | 0.92 |
| 2 | 66 | 4 | 89 | 81 | 0.91 |
| 3 | 58 | 4 | 92 | 83 | 0.91 |
| 4 | 67 | 6 | 87 | 84 | 0.91 |
| 5 | 36 | 29 | 40 | 84 | 0.93 |
| 6 | 64 | 5 | 84 | 84 | 0.94 |
| 7 | 90 | 4 | 88 | 76 | 0.88 |
| 8 | 66 | 4 | 93 | 83 | 0.91 |
| 9 | 60 | 7 | 81 | 71 | 0.87 |
| 10 | 81 | 8 | 79 | 61 | 0.83 |

The data, reflected in the above TABLE, indicate that the proposed method of cobalt catalyst preparation results in catalytic systems characterized by high selectivity to the target product (about 90%) and allowing for production of hydrocarbons with high molecular weight (α>0.9) with low selectivity to the byproduct (methane) formation (mostly, less than 5%).

### INDUSTRIAL APPLICABILITY

This invention is intended for using in petrochemistry, gas chemistry, and coal chemistry, for synthesis of aliphatic hydrocarbons C₅-C₁₀₀, in particular, in the synthesis of hydrocarbons C₅-C₁₀₀ from carbon monoxide and hydrogen.

1. A catalyst for hydrocarbons C₅-C₁₀₀ synthesis, comprising:
an alumina-based support including
aluminum hydroxide of a gibbsite structure, and
cobalt in the amount from 15 to 50 wt. %.

2. The catalyst according to claim 1, wherein said support further including at least one of the metals of groups VII-VIII of Mendeleev's Periodic Table.

3. A method of preparing a catalyst for hydrocarbons C₅-C₁₀₀ synthesis, comprising the steps of:
preparation of an alumina based support by mixing cobalt compounds with aluminum hydroxide and calcination, wherein the aluminum hydroxide having a structure of gibbsite, the mixing provided in the dry form with a mole ratio of cobalt and aluminum in the range of from 1:1 to 1:30;
impregnation of the support in two or more stages with a water solution of cobalt salt; and
thermal treatment.

4. The method according to claim 3, wherein the thermal treatment provided by drying and calcination.

5. The method according to claim 3, wherein promoters additionally introduced into the support through impregnation with salts solution of said promoters.

6. The method according to claim 5, wherein said promoters chosen from the metals of groups VII-VIII of Mendeleev's Periodic Table.

7. The method according to claim 3, wherein the thermal treatment provided by drying or calcination.
